(19) United States
(12) Patent Application Publication
(10) Pub. No.: US 2017/0131824 A1
(43) Pub. Date: May 11, 2017

(54) INFORMATION PROCESSING APPARATUS, INFORMATION PROCESSING METHOD, AND INFORMATION PROCESSING PROGRAM

(71) Applicant: NEC CORPORATION, Tokyo (JP)

(72) Inventor: Akira KAMEI, Tokyo (JP)

(73) Assignee: NEC CORPORATION, Tokyo (JP)

(21) Appl. No.: 15/127,297

(22) PCT Filed: Dec. 22, 2014
(86) PCT No.: PCT/JP2014/083985

§ 371 Date: Sep. 19, 2016

(30) Foreign Application Priority Data
Mar. 20, 2014 (JP) 2014-059240

(51) Int. Cl. G06F 3/041; G06F 3/0484; G06T 3/60; G06F 3/0488; G06T 3/40; G06F 3/0481; G06F 3/0485

(52) U.S. Cl. CPC G06F 3/0416; G06F 3/04817; G06F 3/04842; G06F 3/04845; G06F 3/0485; G06F 3/0488; G06T 3/40; G06T 3/60; G06F 2203/04808; G06F 2203/04104

(57) ABSTRACT

An apparatus according to this invention is an information processing apparatus for allowing the user to accurately designate a desired region on a display screen by a simple operation. The information processing apparatus includes a touch detector that detects the presence of a first touch and a second touch on a touch panel, a position change detector that detects a change in a position of each of the first touch and the second touch, and an estimator that estimates that the change in the position of the first touch is to set a designated region in a screen displayed on the touch panel, if the position change detector detects the change in the position of the first touch and detects no change in the position of the second touch.

### TECHNICAL FIELD

The present invention relates to an information processing apparatus including a touch panel, an information processing method, and an information processing program.

### BACKGROUND ART

In the above technical field, patent literature 1 discloses a technique of restricting scroll at the time of a drag operation on a touch panel. Patent literature 2 discloses a technique of making the user touch a touch panel with two fingers to scroll a display screen with one finger and instruct a link with the other finger.

### CITATION LIST

### Patent Literature

Patent literature 1: Japanese Patent Laid-Open No. 2013-092942

Patent literature 2: International Publication No. 2009/044770

### SUMMARY OF THE INVENTION

### Technical Problem

The techniques described in the above literatures, however, cannot prevent the problem that a screen is unwantedly scrolled by a user operation of designating a region on the display screen and thus the user cannot accurately designate a desired region.

The present invention enables to provide a technique of solving the above-described problem.

### Solution to Problem

One aspect of the present invention provides an apparatus comprising:

a touch detector that detects presence of a first touch and a second touch on a touch panel;

a position change detector that detects a change in a position of each of the first touch and the second touch; and

a designated region setting estimator that estimates that the change in the position of the first touch is to set a designated region in a screen displayed on the touch panel, if said position change detector detects the change in the position of the first touch and detects no change in the position of the second touch.

Another aspect of the present invention provides a method comprising:

detecting presence of a first touch and a second touch on a touch panel;

detecting a change in a position of each of the first touch and the second touch; and

estimating that the change in the position of the first touch is to set a designated region in a screen displayed on the touch panel, if the change in the position of the first touch is detected and no change in the position of the second touch is detected in the detecting the change.

Still other aspect of the present invention provides a program for causing a computer to execute a method, comprising:

detecting presence of a first touch and a second touch on a touch panel;

detecting a change in a position of each of the first touch and the second touch; and

estimating that the change in the position of the first touch is to set a designated region in a screen displayed on the touch panel, if the change in the position of the first touch is detected and no change in the position of the second touch is detected in the detecting the change.

### Advantageous Effects of Invention

According to the prevent invention, the user can accurately designate a desired region on a display screen by a simple operation.

### BRIEF DESCRIPTION OF DRAWINGS

FIG. 1 is a block diagram showing the arrangement of an information processing apparatus according to the first embodiment of the present invention;

FIG. 2 is a view for explaining designated region setting in an information processing apparatus according to the second embodiment of the present invention;

FIG. 3 is a view for explaining the designated region setting in the information processing apparatus according to the second embodiment of the present invention;

FIG. 4A is a view showing the outer appearance of the information processing apparatus according to the second embodiment of the present invention;

FIG. 4B is a block diagram showing the arrangement of the information processing apparatus according to the second embodiment of the present invention;

FIG. 5 is a block diagram showing the functional arrangement of a screen operation processor according to the second embodiment of the present invention;

FIG. 6 is a block diagram showing the functional arrangement of an operation acceptor according to the second embodiment of the present invention;

FIG. 7 is a block diagram showing the functional arrangement of an operation analyzer according to the second embodiment of the present invention;

FIG. 8A is a block diagram showing the functional arrangement of a user operation determiner according to the second embodiment of the present invention;

FIG. 8B is a table showing the structure of a user operation determination table according to the second embodiment of the present invention;

FIG. 9 is a block diagram showing the functional arrangement of a display controller according to the second embodiment of the present invention;

FIG. 10 is a flowchart illustrating the procedure of screen operation processing by the information processing apparatus according to the second embodiment of the present invention;

FIG. 11 is a flowchart illustrating the procedure of designated region estimation processing according to the second embodiment of the present invention;

FIG. 12 is a view for explaining designated region setting in an information processing apparatus according to the third embodiment of the present invention;

FIG. 13 is a table showing the structure of a user operation determination table according to the third embodiment of the present invention;

FIG. 14 is a flowchart illustrating the procedure of designated region setting processing according to the third embodiment of the present invention;

FIG. 15 is a view for explaining designated region setting in an information processing apparatus according to the fourth embodiment of the present invention;

FIG. 16 is a block diagram showing the functional arrangement of an operation analyzer according to the fourth embodiment of the present invention;

FIG. 17A is a block diagram showing the functional arrangement of a user operation determiner according to the fourth embodiment of the present invention;

FIG. 17B is a table showing the structure of a user operation determination table according to the fourth embodiment of the present invention;

FIG. 18 is a flowchart illustrating the procedure of screen operation processing by the information processing apparatus according to the fourth embodiment of the present invention;

FIG. 19 is a view showing an example of a screen operation of an information processing apparatus according to another embodiment of the present invention; and

FIG. 20 is a view showing an example of a screen operation of the information processing apparatus according to still other embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

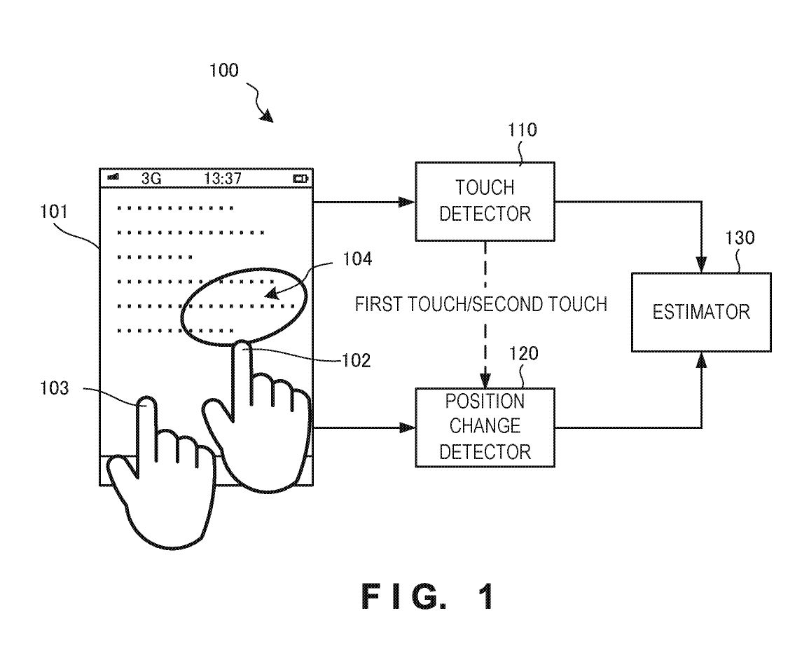

An information processing apparatus 100 according to the first embodiment of the present invention will be described with reference to FIG. 1. The information processing apparatus 100 is an apparatus for controlling designated region setting on a display screen.

As shown in FIG. 1, the information processing apparatus 100 includes a touch detector 110, a position change detector 120, and a designated region estimator 130. The touch detector 110 detects the presence of a first touch 102 and a second touch 103 on a touch panel 101. The position change detector 120 detects a change in the position of each of the first touch 102 and the second touch 103. If the position change detector 120 detects a change in the position of the first touch 102 and detects no change in the position of the second touch 103, the estimator 130 estimates that the change in the position of the first touch 102 is to set a designated region 104 in a screen displayed on the touch panel 101.

The information processing apparatus 100 detects the start of some operation from the user on the touch panel 101, and starts accepting operation data. The touch detector 110 detects position coordinates on the touch panel 101 touched by a user's finger. The position change detector 120 detects a stroke based on a temporal change in the position of the touch. The estimator 130 estimates a touch for designated region setting based on detection of a change in the position of each of two touches.

According to this embodiment, the user can accurately designate a desired region on the display screen by a simple operation of two touches.

### Second Embodiment

An information processing apparatus according to the second embodiment of the present invention will be described next. If two touch operations are performed on a touch panel, when a change in the position of the first touch is detected, the information processing apparatus according to this embodiment estimates that the first touch is to set a designated region in a screen. The information processing apparatus estimates that the second touch for which no change in the position is detected is to scroll the screen. After that, when a change in the position of the second touch is detected, the information processing apparatus scrolls the screen in accordance with the change in the position. The roles of the two touches according to this embodiment are distinguished between a rotation operation and scaling processing of an existing pinch-in operation (scaling-down display processing) and pinch-out operation (scaling-up display processing).

### Designated Region Setting of Embodiment

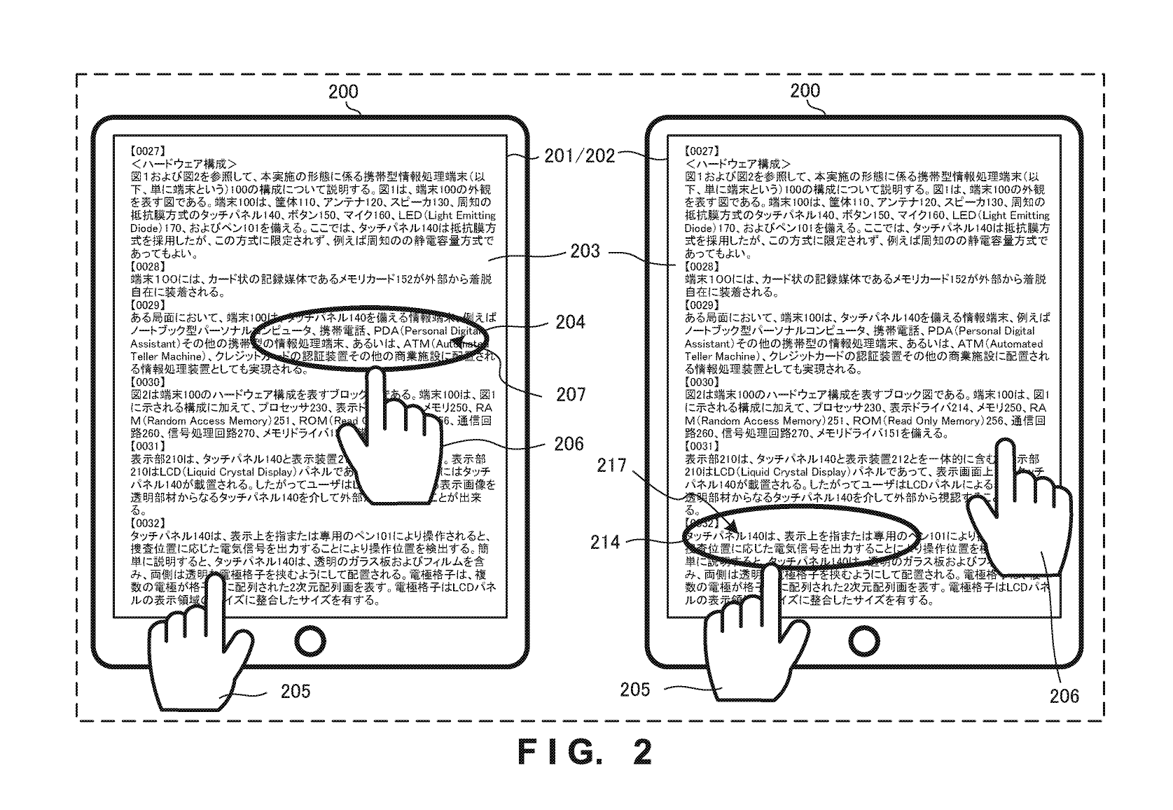

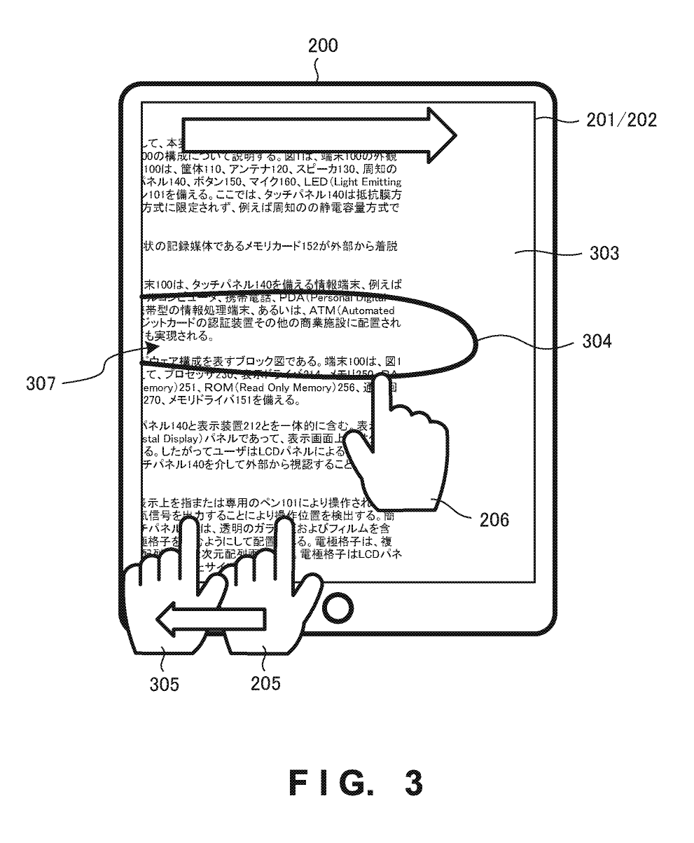

An overview of designated region setting by the information processing apparatus according to this embodiment will be described with reference to FIGS. 2 and 3.

FIG. 2 is a view for explaining designated region setting in an information processing apparatus 200 according to this embodiment. The left view of FIG. 2 shows a state in which the role of scroll is allotted to a touch with a left hand and the role of designated region setting is allotted to a touch with a right hand. On the other hand, the right view of FIG. 2 shows a state in which the role of designated region setting is allotted to a touch with a left hand and the role of scroll is allotted to a touch with a right hand.

In the left view of FIG. 2, a document 203 is displayed on a display panel unit 202. Two touch operations are performed by a left hand 205 and right hand 206 on a touch panel 201. In this example, a change in the position of the touch with the right hand 206 is detected while no change in the position of the touch with the left hand 205 is detected. In this state, the role of scroll is allotted to the touch with the left hand 205 and the role of designated region setting is allotted to the touch with the right hand 206. The touch with the right hand 206 draws a closed curve 204, thereby selecting an internal region 207 of the closed curve 204.

On the other hand, the right view of FIG. 2 shows a state in which a change in the position of the touch with the left hand 205 is detected while no change in the position of the touch with the right hand 206 is detected. In this state, the role of designated region setting is allotted to the touch with the left hand 205 and the role of scroll is allotted to the touch with the right hand 206. The touch with the left hand 205 draws a closed curve 214, thereby selecting an internal region 217 of the closed curve 214.

FIG. 3 is a view for explaining designated region setting in the information processing apparatus 200 according to this embodiment. FIG. 3 shows scroll by a change in the position of a touch for scroll.

FIG. 3 shows a change in the position of the left hand 205 to a left hand 305 after the role of scroll is allotted to the touch with the left hand 205 and the role of designated region setting is allotted to the touch with the right hand 206, as shown in the left view of FIG. 2. At this time, the screen is scrolled leftward as indicated by a document 303 along with the moving direction of the touch with the left hand, and the closed curve 204 and its internal region 207 are scrolled to a closed curve 304 and internal region 307.

### Information Processing Apparatus

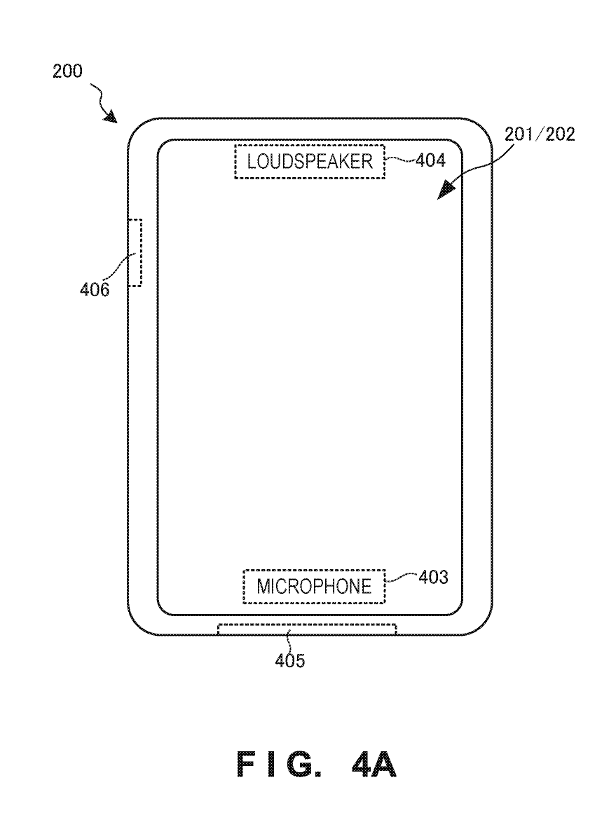

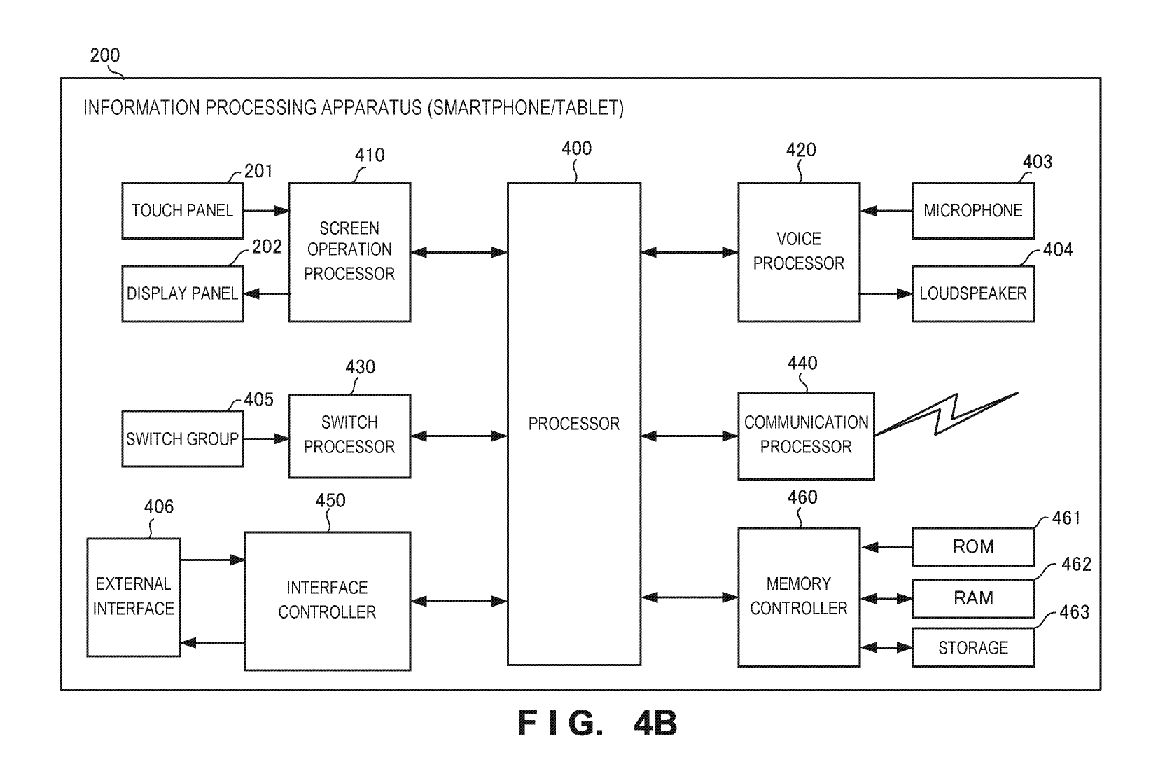

FIG. 4A is a view showing the outer appearance of the information processing apparatus 200 according to this embodiment. Note that FIG. 4A shows a portable terminal using a touch panel, such as a smartphone or tablet. However, the information processing apparatus according to this embodiment is not limited to the smartphone or tablet.

In the information processing apparatus 200, the touch panel 201 and the display panel unit 202 function as an operation unit and a display unit, respectively. The information processing apparatus 200 includes a microphone 403 and a loudspeaker 404 as a voice input/output function. The information processing apparatus 200 also includes a switch group 405 including a power switch. Furthermore, the information processing apparatus 200 includes an external interface 406 used for external input/output device connection and communication connection.

### Functional Arrangement of Information Processing Apparatus

FIG. 4B is a block diagram showing the arrangement of the information processing apparatus 200 according to this embodiment. Note that FIG. 4B shows the basic arrangement of the portable terminal using the touch panel, such as a smartphone or tablet. The present invention, however, is not limited to this. Each component shown in FIG. 4B may be implemented by a single hardware component, software by including a proprietary processor to execute a program, or firmware by combining hardware and software. Each component shown in FIG. 4B is separated from other components to independently implement its function. In fact, however, each component is implemented by a combination of multilayer controls from bottom layer control by basic hardware and OS (Operating System) and input/output control to top layer control by an application program.

A processor 400 includes at least one CPU (Central Processing Unit), and controls the overall information processing apparatus 200. Note that the processor 400 desirably incorporates a unique memory. A screen operation processor 410 is a component for performing processing according to this embodiment. The screen operation processor 410 accepts a user operation input from the touch panel 201, changes a display screen in correspondence with the user operation input, and displays the screen on the display panel unit 202. Note that the screen operation processor 410 may be implemented by executing an associated program by the processor 400 but an independent screen operation processor is desirably provided. A voice processor 420 processes a voice input from the microphone 403 to, for example, transmit the voice input via a communication processor 440 or send a user voice instruction changed to a user operation input from the touch panel 201. The voice processor 420 generates a notification/warning to the user, a video reproduction voice, or the like, and outputs a voice from the loudspeaker. The voice processor 420 is also desirably provided with a voice processing processor independent of the processor 400.

A switch processor 430 executes processing based on a switch input from the switch group 405. The communication processor 440 transmits/receives data via a network. An interface controller 450 controls data input/output to/from an input/output device connected via the external interface 406. The communication processor 440 is also desirably provided with a voice processing processor independent of the processor 400. For example, a memory controller 460 controls exchange of data and programs between the processor 400 and a ROM (Read Only Memory) 461 which is formed by a flash memory and the like, RAM (Random Access Memory) 462, and storage 463. The memory controller 460 is also desirably provided with a voice processing processor independent of the processor 400.

The screen operation processor 410 according to this embodiment will be described in more detail below.

### Screen Operation Processor

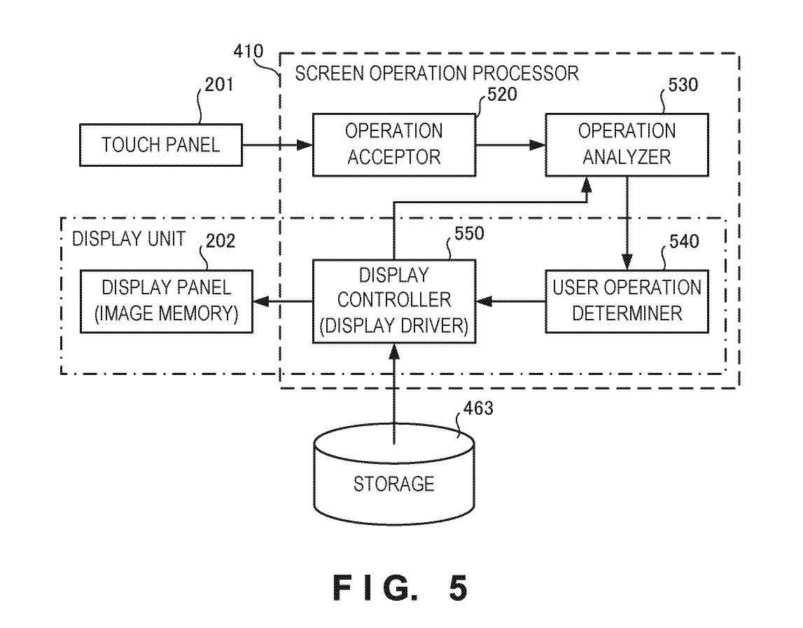

FIG. 5 is a block diagram showing the functional arrangement of the screen operation processor 410 according to this embodiment.

The screen operation processor 410 includes an operation acceptor 520, an operation analyzer 530, a user operation determiner 540, and a display controller 550. The operation acceptor 520 accepts a user operation from the touch panel 201, and acquires a touch position and an operation. The operation analyzer 530 analyzes operation contents in consideration of information of the display screen based on the user operation and position accepted by the operation acceptor 520. In this embodiment, the operation analyzer 530 especially detects two touches on the touch panel, detects a change in the position of each touch, and stores a history of the change in the position. Based on the operation contents analyzed by the operation analyzer 530, the user operation determiner 540 determines an operation desired by the user. In this embodiment, based on detection of a change in the position of each of two touches, the user operation determiner 540 estimates a touch for designated region setting. The display controller 550 includes a display driver, and reads out display information in a display information database (to be referred to as a DB hereinafter) 570 in the storage 463 and controls the screen on the display panel unit 202 by changing an image memory so as to implement, on the display screen, the operation desired by the user in accordance with the determination result of the user operation determiner 540. The display information DB 570 stores information to be displayed on the display panel unit 202 under the control of the display controller 550. The display information includes all contents of a document or the like. The display information DB 570 may be provided in, for example, the storage 463 shown in FIG. 4.

Note that the functional components shown in FIG. 5 may be implemented by the processing of the processor of the screen operation processor 410, or some functional components may be processed by a proprietary processor to increase the processing speed. Each functional component shown in FIG. 5 is limited to the operation of the screen operation processor 410 but may exchange data with other components of the information processing apparatus 200 shown in FIG. 4B.

### Operation Acceptor

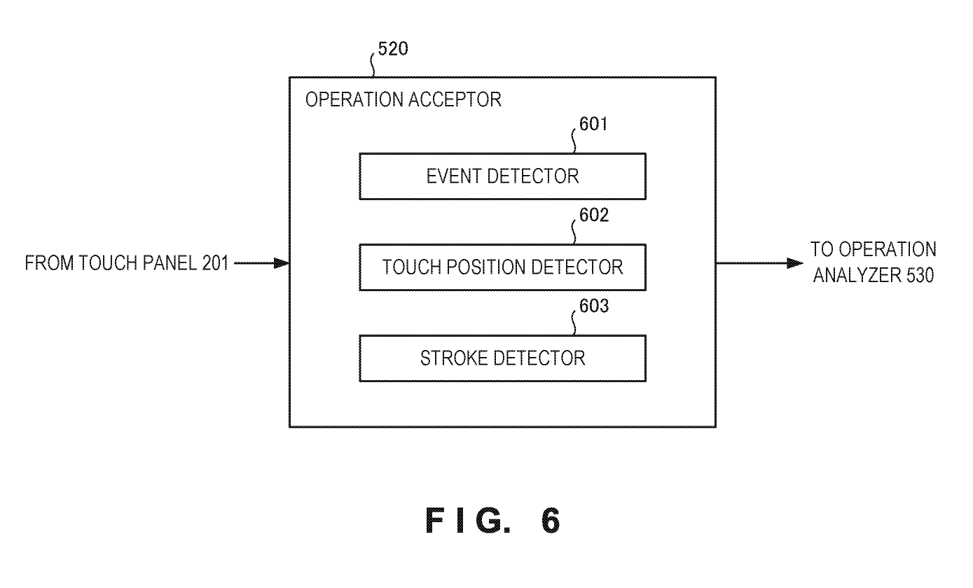

FIG. 6 is a block diagram showing the functional arrangement of the operation acceptor 520 according to this embodiment. The operation acceptor 520 accepts a user operation from the touch panel 201, and acquires a touch position and an operation.

The operation acceptor 520 includes an event detector 601, a touch position detector 602, and a stroke detector 603. The event detector 601 detects the start of some operation from the user on the touch panel 201, and starts accepting operation data. The touch position detector 602 detects position coordinates on the touch panel 201 touched by a user's finger. The stroke detector 603 detects a stroke based on a temporal change in the position of a user's touch.

### Operation Analyzer

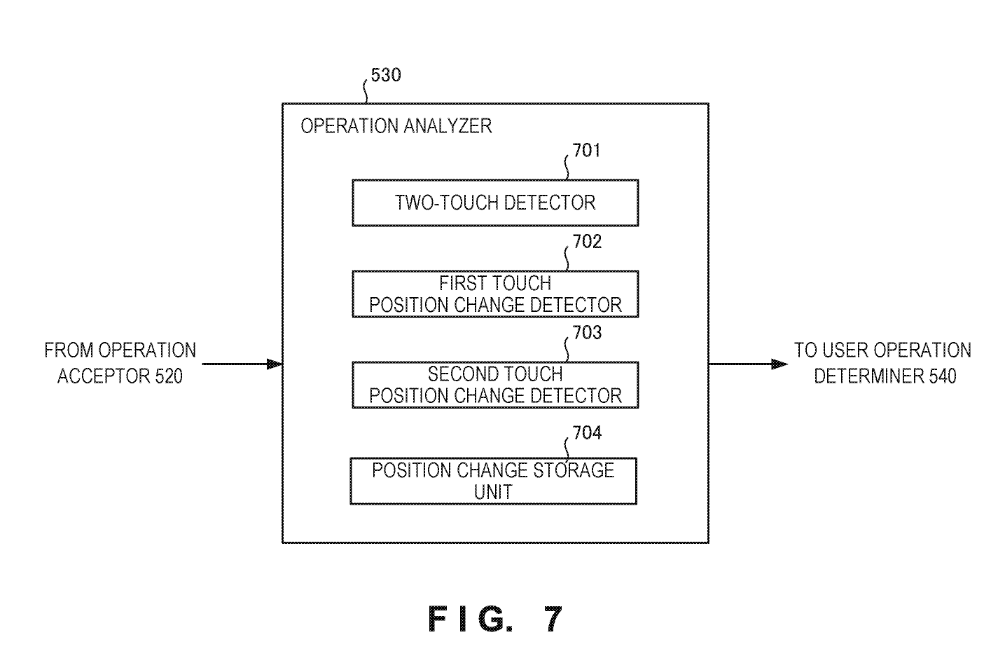

FIG. 7 is a block diagram showing the functional arrangement of the operation analyzer 530 according to this embodiment. The operation analyzer 530 analyzes operation contents in consideration of the information of the display screen based on the user operation and position accepted by the operation acceptor 520.

The operation analyzer 530 according to this embodiment includes a two-touch detector 701, a first touch position change detector 702, a second touch position change detector 703, and a position change storage unit 704. The two-touch detector 701 detects whether two touch operations are performed on the touch panel. If two touch operations are performed, the first touch position change detector 702 and the second touch position change detector 703 detect changes in the positions of the touches on the touch panel, respectively. The position change storage unit 704 stores a history of a change in the position of each touch. The information in the position change storage unit 704 is used to estimate the operation of each touch desired by the user. In this embodiment, for example, the information is used to determine region designation or the like on the screen.

Note that the functional arrangement of the operation analyzer 530 specializes in the operation according to this embodiment. A general-purpose functional arrangement and the like are not shown.

### User Operation Determiner

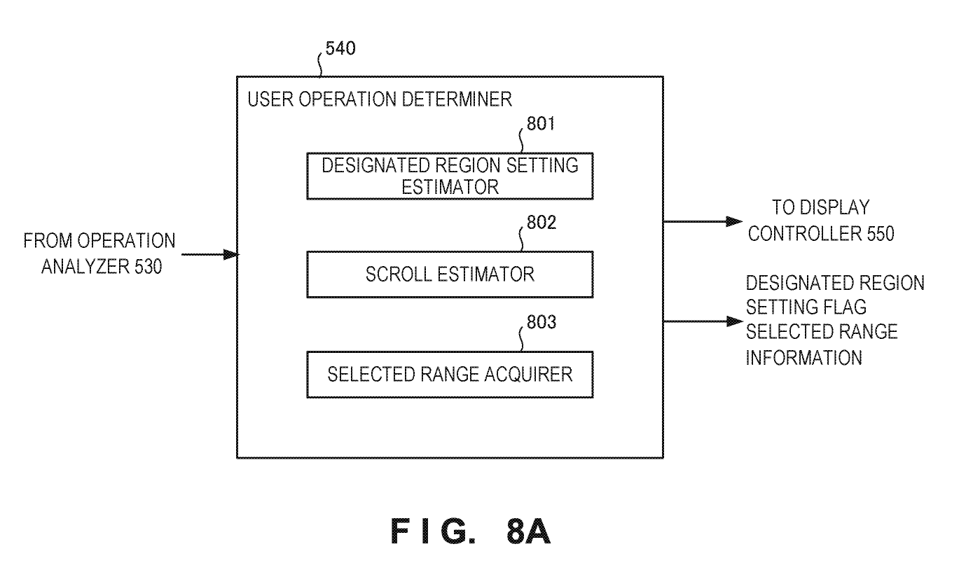

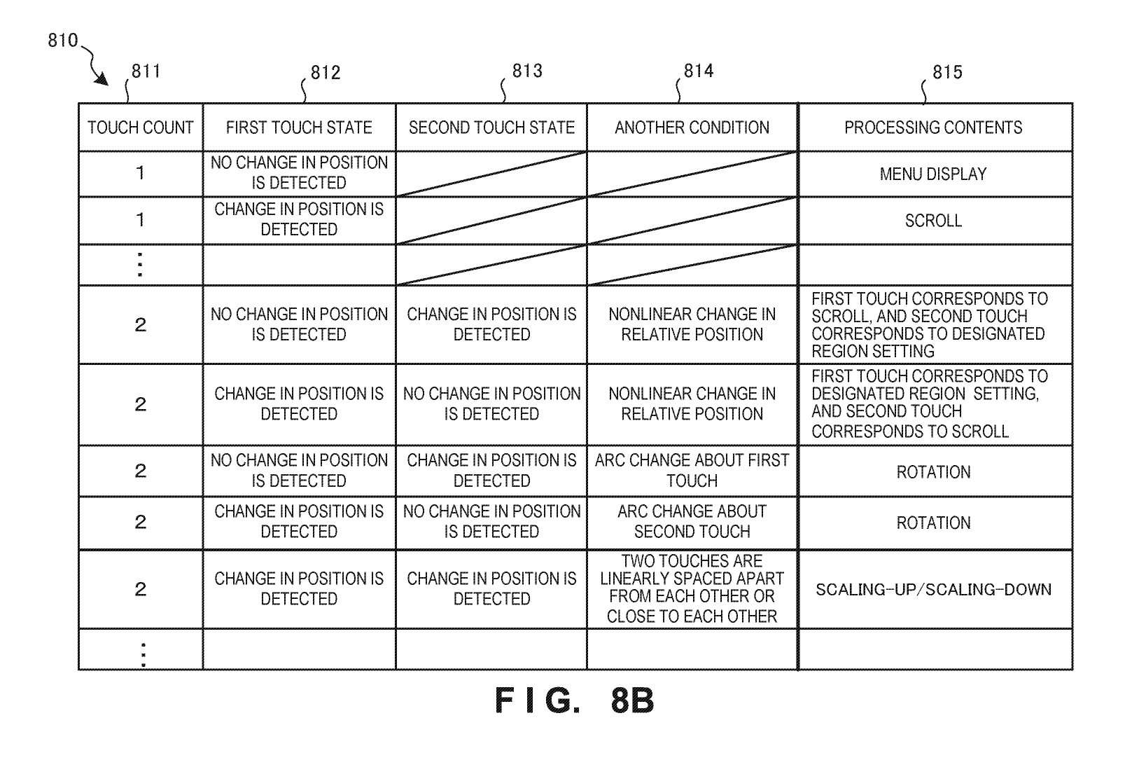

FIG. 8A is a block diagram showing the functional arrangement of the user operation determiner 540 according to this embodiment. The user operation determiner 540 determines the operation desired by the user based on the operation contents analyzed by the operation analyzer 530.

The user operation determiner 540 includes a designated region setting estimator 801, a scroll estimator 802, and a selected range acquirer 803. The designated region setting estimator 801 estimates, using the analysis result of the touch operation in the operation analyzer 530, that the touch is to set a designated region in the screen displayed on the touch panel. The scroll estimator 802 estimates, using the analysis result of the touch operation in the operation analyzer 530, that the touch is to scroll the screen displayed on the touch panel. The selected range acquirer 803 acquires data within the selected range by the touch which has been estimated, by the designated region setting estimator 801, to set the designated region in the screen, in this example, a portion of the document.

Note that the user operation determiner 540 determines a user operation such as “pinch (scaling processing)”, “drag”, or “scroll” as another touch panel operation.

FIG. 8B is a table showing the structure of a user operation determination table 810 according to this embodiment. The user operation determination table 810 is used by the user operation determiner 540 to determine a user operation based on a touch operation by a user's finger.

The user operation determination table 810 stores processing contents 815 in association with a touch count 811, first touch state 812, second touch state 813, and another condition 814.

For example, the processing contents according to this embodiment include the following. When a change in the position of one of the first and second touches is detected and no change in the position of the other touch is detected, if a change in the relative position of the two touches is nonlinear, the touch for which the change in the position is detected is estimated to set a designated region, and the touch for which no change in the position is detected is estimated to scroll the screen. When a change in the position of one of the first and second touches is detected and no change in the position of the other touch is detected, if one touch draws an arc about the other touch, rotation processing of the display screen is estimated. Note that even if changes in the positions of both the touches are detected, if the two touches rotate about an axis, rotation processing of the display screen may be estimated. If changes in the positions of the first and second touches are detected and the two touches are linearly spaced apart from each other or close to each other, a pinch operation (scaling-up/scaling-down display processing processing) is estimated. Note that even if no change in the position of one of the touches is detected, if the touches are linearly spaced apart from each other or close to each other, a pinch operation (scaling-up/scaling-down display processing) may be estimated.

Note that with respect to determination of whether the two touches are linearly spaced apart from each other or close to each other, or a change in the relative position is nonlinear, for example, if a change in the tilt of a straight line connecting the two touches does not exceed a predetermined threshold, linearity is determined. The threshold is appropriately set based on the accumulation of experience values.

### Display Controller

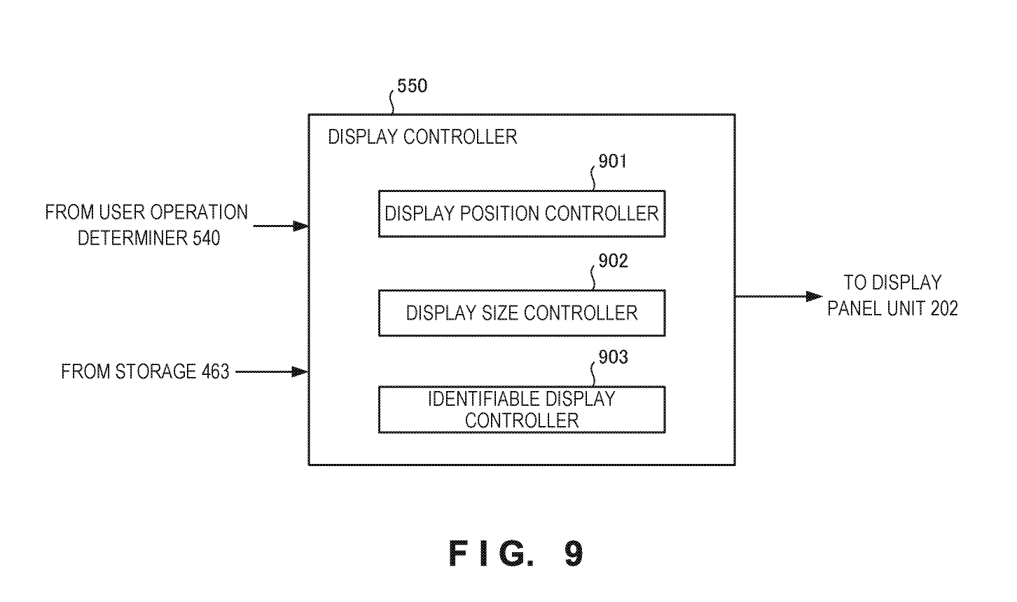

FIG. 9 is a block diagram showing the functional arrangement of the display controller 550 according to this embodiment. The display controller 550 includes a display driver. The display controller 550 reads out the display information in the display information DB 570, and controls the screen on the display panel unit 202 in accordance with the determination result of the user operation determiner 540. It is possible to implement the operation desired by the user on the display screen under the control of the display controller 550.

The display controller 550 includes a display position controller 901, a display size controller 902, and an identifiable display controller 903. The display position controller 901 controls a position of the display information read out from the display information DB 570 to be displayed. In this embodiment, the display position controller 901 controls the display position of the document in accordance with an operation such as scroll or rotation. The display size controller 902 controls the size of the display information to be displayed on the display screen, that is, a magnification. In this embodiment, for example, the display size controller 902 controls a display size in the case of a pitch operation. The identifiable display controller 903 controls to identifiably display the document for which designated region setting has been made on the display screen. In this embodiment, in accordance with the determination result of the user operation determiner 540, the identifiable display controller 903 identifiably displays a portion of the document, where a designated region has been set.

### Procedure of Screen Operation Processing

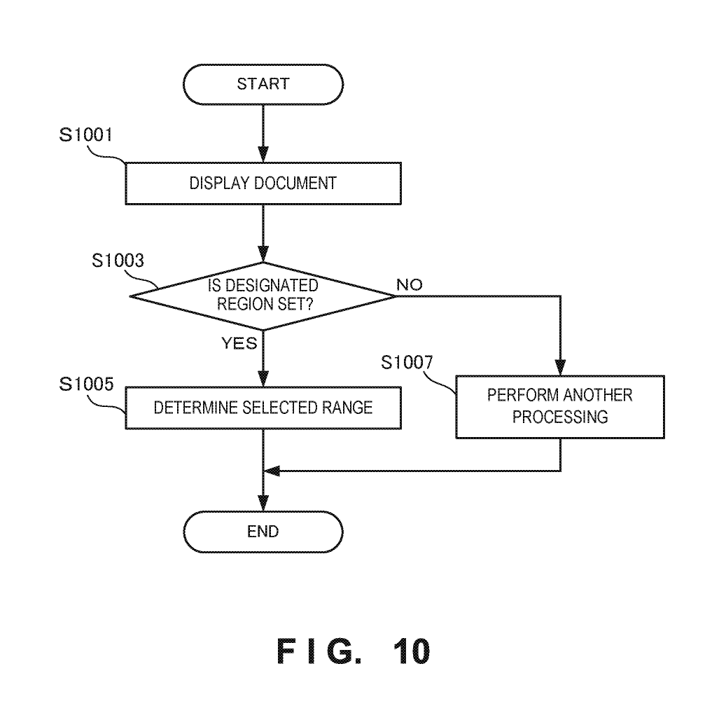

FIG. 10 is a flowchart illustrating the procedure of screen operation processing by the information processing apparatus 200 according to this embodiment. This flowchart implements the respective functional components of the screen operation processor 410 when executed by the processor 400 or the CPU of the screen operation processor 410. A case in which the CPU of the screen operation processor 410 executes the flowchart will be described.

In step S1001, the screen operation processor 410 displays a predetermined portion of a document designated, by the user, to be displayed, as shown in FIG. 2 or 3. In step S1003, the screen operation processor 410 estimates whether the user sets a designated region in the display document. If the user sets a designated region in the display document, the screen operation processor 410 determines a selected range within the region in step S1005. On the other hand, if the user does not set a designated region in the display document, the screen operation processor 410 performs another processing in step S1007.

### Designated Region Setting Estimation Processing

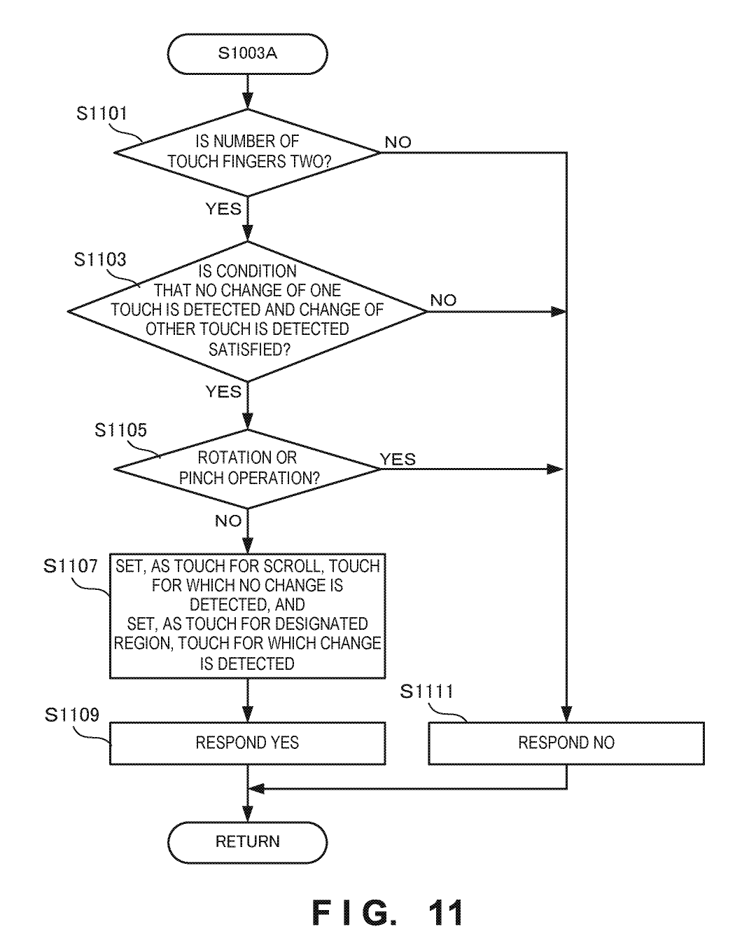

FIG. 11 is a flowchart illustrating the procedure of designated region setting estimation processing (S1003A) according to this embodiment. Step S1003A is a detailed flowchart of step S1003 of FIG. 10 according to this embodiment.

In step S1101, the screen operation processor 410 determines whether the number of touch fingers is two. If the number of touch fingers is two, the screen operation processor 410 determines in step S1103 whether no change in the position of one touch has been detected and a change in the position of the other touch has been detected. If no change in the position of one touch has been detected and a change in the position of the other touch has been detected, the screen operation processor 410 determines in step S1105 whether the condition of a rotation or pinch operation is satisfied. If the condition of a rotation or pinch operation is not satisfied, in step S1107 the screen operation processor 410 sets, as a touch for scroll, the touch for which no change in the position has been detected, and sets, as a touch for designated region setting, the touch for which the change in the position has been detected. The screen operation processor 410 responds “YES” in step S1109, and returns to the flowchart of FIG. 10.

On the other hand, if not all the above conditions are satisfied, the screen operation processor 410 responds “NO” in step S1111, and returns to the flowchart of FIG. 10.

According to this embodiment, if two touch operations are performed on the touch panel, the roles of designated region setting and scroll are allotted by distinguishing the touches from the existing operations of two finger touches. The user can thus accurately designate a desired region on the display screen by a simple operation.

### Third Embodiment

An information processing apparatus according to the third embodiment of the present invention will be described next. The information processing apparatus according to this embodiment is different from that according to the second embodiment in that the roles of two touches are estimated based on touch positions. That is, a touch within a predetermined region at a corner of a touch panel is estimated as a touch for scroll, and a touch in the remaining central portion of the touch panel is estimated as a touch for designated region setting. The remaining components and operations are the same as those in the second embodiment. Hence, the same reference numerals denote the same components and operations, and a detailed description thereof will be omitted.

### Designated Region Setting of Embodiment

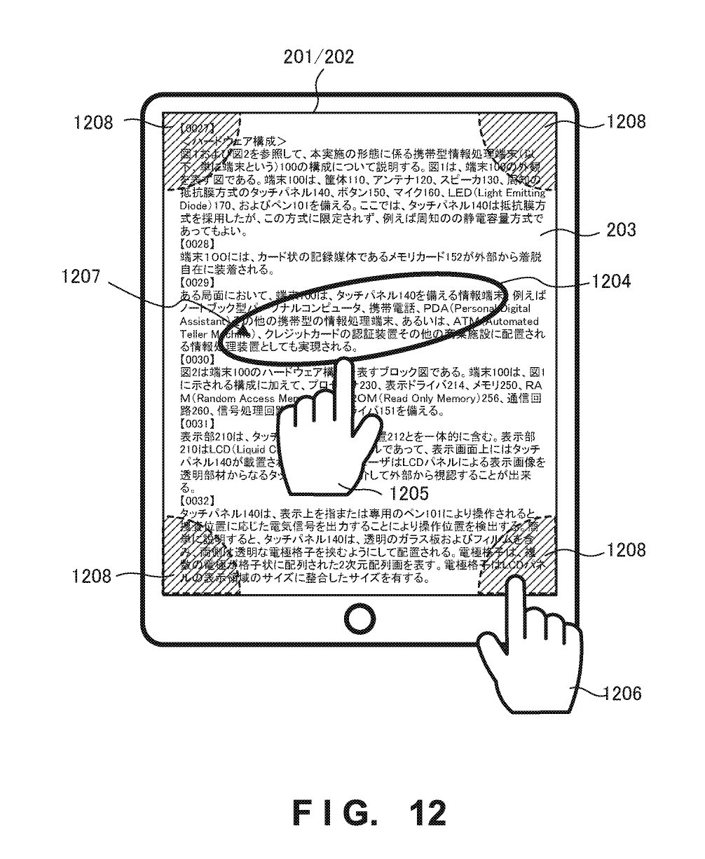

FIG. 12 is a view for explaining designated region setting in an information processing apparatus 200 according to this embodiment. Note that in FIG. 12, the same reference numerals as in FIG. 2 denote the same components and a description thereof will be omitted.

Referring to FIG. 12, if a touch is detected in one of predetermined regions 1208 at the four corners of a touch panel 201, the role of scroll is allotted to the touch, and the role of designated region setting is allotted to the other touch. In FIG. 12, a right hand 1206 is set for scroll, and a left hand 1205 is set for designated region setting. An internal region 1207 of a closed curve 1204 drawn by a touch with the left hand 1205 is selected.

### User Operation Determiner

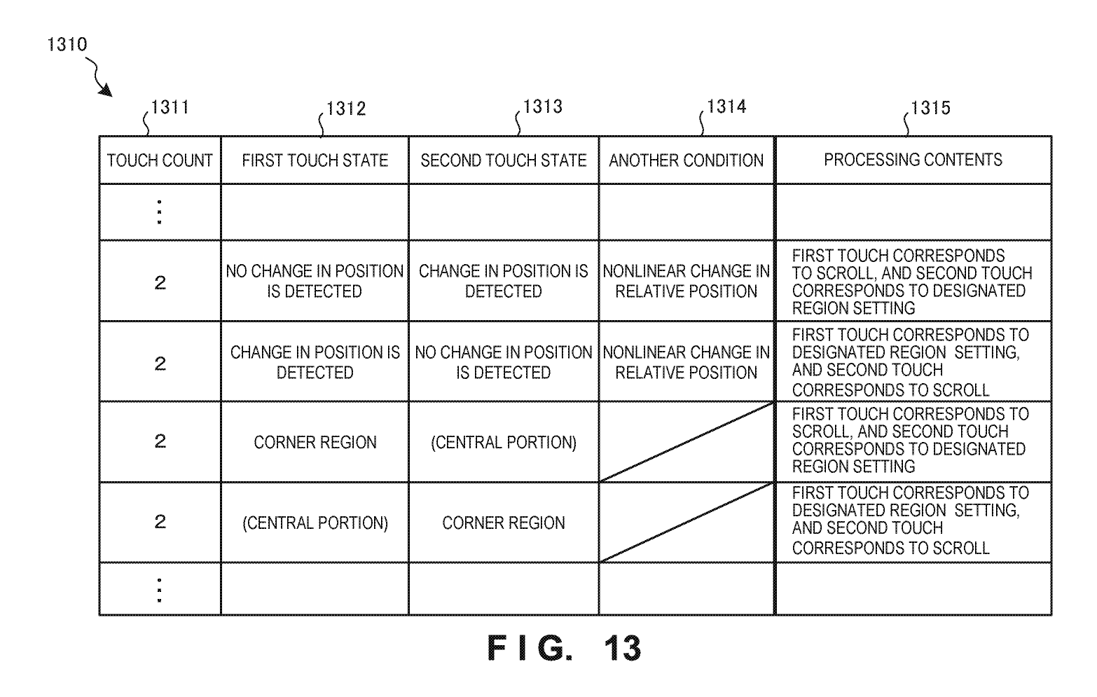

FIG. 13 is a table showing the structure of a user operation determination table 1310 according to this embodiment. The user operation determination table 1310 is used by a user operation determiner 540 to determine a user operation based on a touch operation by a user's finger.

The user operation determination table 1310 stores processing contents 1315 in association with a touch count 1311, first touch state 1312, second touch state 1313, and another condition 1314. Note that a case in which the touch count is “2” and the roles of designated region setting and scroll are allotted will be described with reference to FIG. 13.

As in the second embodiment, when a change in the position of one of the first and second touches is detected and no change in the position of the other touch is detected, if a change in the relative position of the two touches is nonlinear, the touch for which the change in the position is detected is estimated to set a designated region, and the touch for which no change in the position is detected is estimated to scroll a screen.

In this embodiment, the touch in the corner region is estimated to scroll the screen, and the touch outside the corner regions (in the central portion) is estimated to set a designated region. In this case, another condition is not specifically needed. Note that a portion on the touch panel to be set as a corner region is not limited. A corner region where no document is displayed or a corner region where a designated region is set at low probability is appropriately set.

### Designated Region Setting Estimation Processing

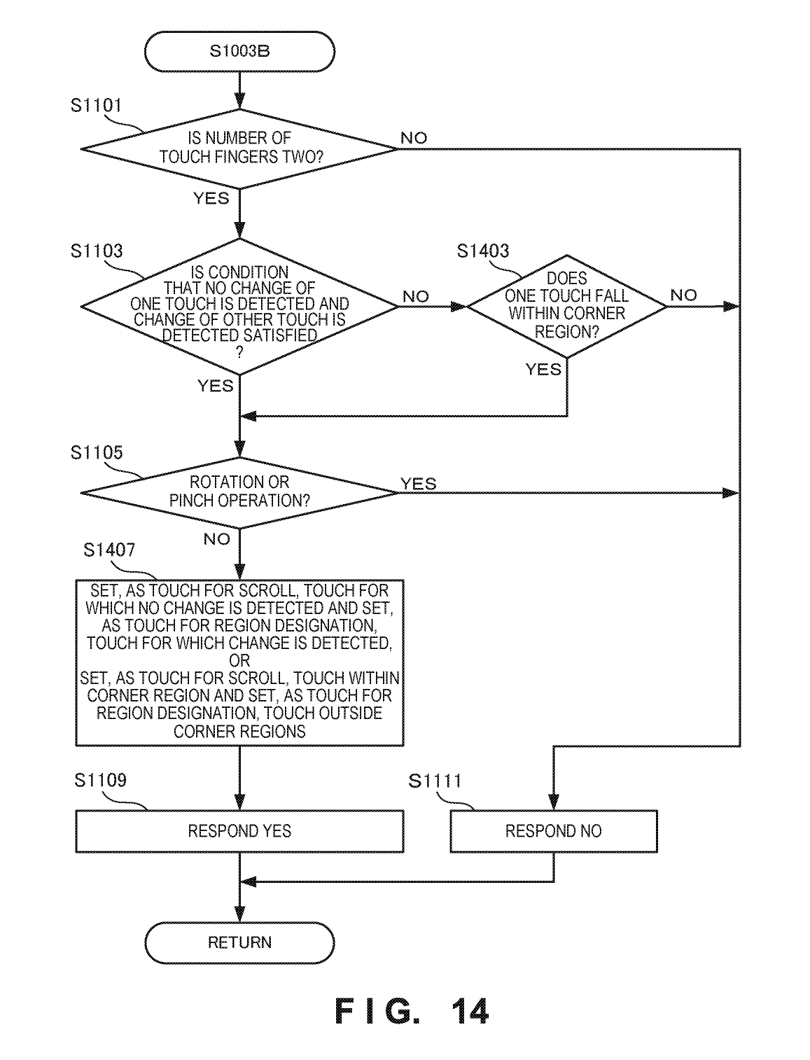

FIG. 14 is a flowchart illustrating the procedure of designated region setting estimation processing (S1003B) according to this embodiment. Step S1003B is a detailed flowchart of step S1003 of FIG. 10 according to this embodiment. Note that in FIG. 14, the same step numbers as in FIG. 11 denote the same steps and a description thereof will be omitted.

In step S1403, a screen operation processor 410 determines whether one of touches falls within a predetermined region at a corner. If one of touches falls within a predetermined region at a corner, the screen operation processor 410 advances to step S1105. In step S1407, the screen operation processor 410 sets, as a touch for scroll, the touch for which no change in the position is detected and sets, as a touch for designated region setting, the touch for which the change in the position is detected, or sets, as a touch for scroll, the touch within the predetermined region at the corner and sets, as a touch for designated region setting, the touch outside the predetermined regions at the corners.

According to this embodiment, if two touch operations are performed on the touch panel, the roles of designated region setting and scroll are allotted based on the positions of the touches by distinguishing the touches from the existing operations of two finger touches. The user can thus accurately designate a desired region on the display screen by a simpler operation.

### Fourth Embodiment

An information processing apparatus according to the fourth embodiment of the present invention will be described next. The information processing apparatus according to this embodiment is different from those according to the second and third embodiments in that if two long-touch operations are performed after a designated region setting operation, a selection icon capable of selecting processing following the designated region setting appears. The remaining components and operations are the same as those in the second and third embodiments.

Hence, the same reference numerals denote the same components and operations, and a detailed description thereof will be omitted.

### Designated Region Setting of Embodiment

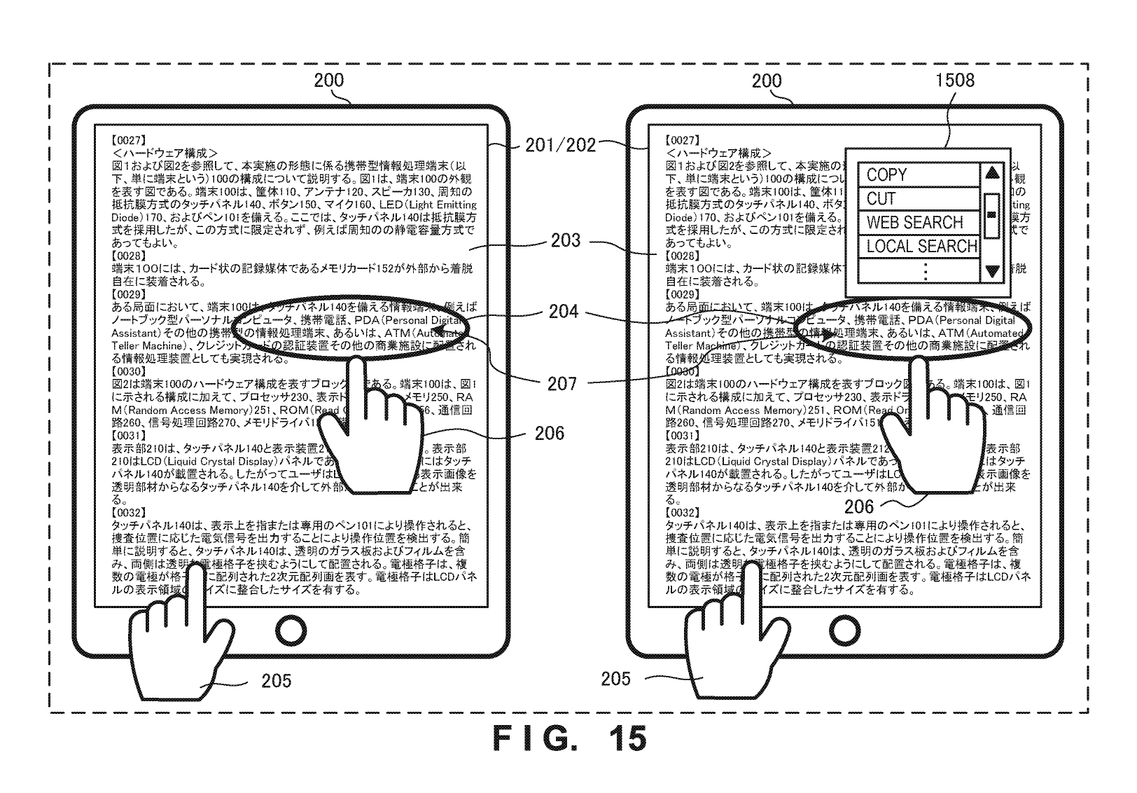

FIG. 15 is a view for explaining designated region setting in an information processing apparatus 200 according to this embodiment. Note that in FIG. 15, the same reference numerals as in FIG. 2 denote the same components and a description thereof will be omitted.

The left view of FIG. 15 is the same as that of FIG. 2, and shows a state in which the role of scroll is allotted to a left hand 205, the role of designated region setting is allotted to a right hand 206, a touch with the right hand 206 draws a closed curve 204, and an internal region 207 of the closed curve 204 is selected. In this state, if both the right hand 206 and the left hand 205 respectively perform long touch operations, a selection icon 1508 appears to allow the user to select subsequent processing, as shown in the right view of FIG. 15. Note that “copy”, “cut”, “Web search”, “local search”, and the like of a document in the internal region 207 are shown in the selection icon 1508 of FIG. 15. The present invention, however, is not limited to them.

### Operation Analyzer

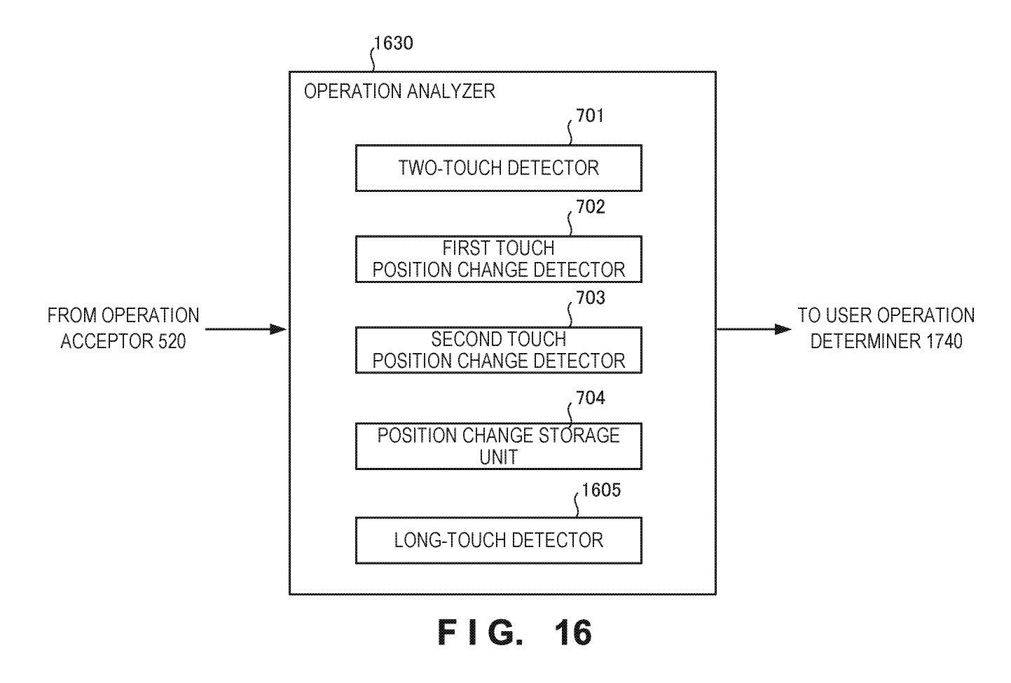

FIG. 16 is a block diagram showing the functional arrangement of an operation analyzer 1630 according to this embodiment. Note that in FIG. 16, the same reference numerals as in FIG. 7 denote the same functional components and a description thereof will be omitted.

Based on touch position information from an operation acceptor 520, a long-touch detector 1605 of the operation analyzer 1630 detects whether each touch is a long touch. For example, if a touch at the same position continues for a period longer than a predetermined threshold, the touch is determined as a long touch.

### User Operation Determiner

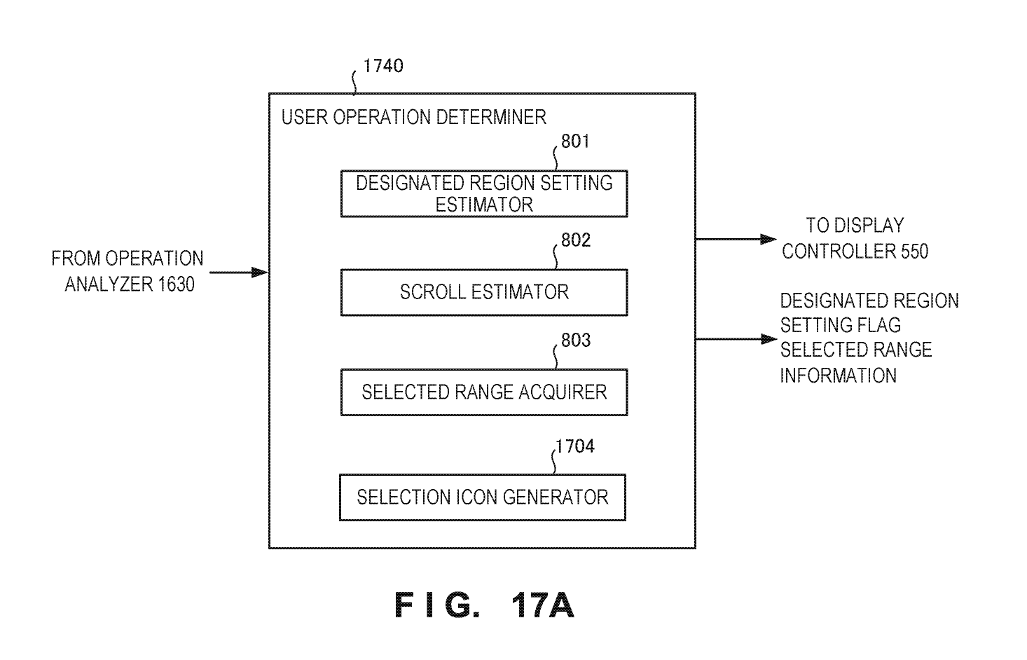

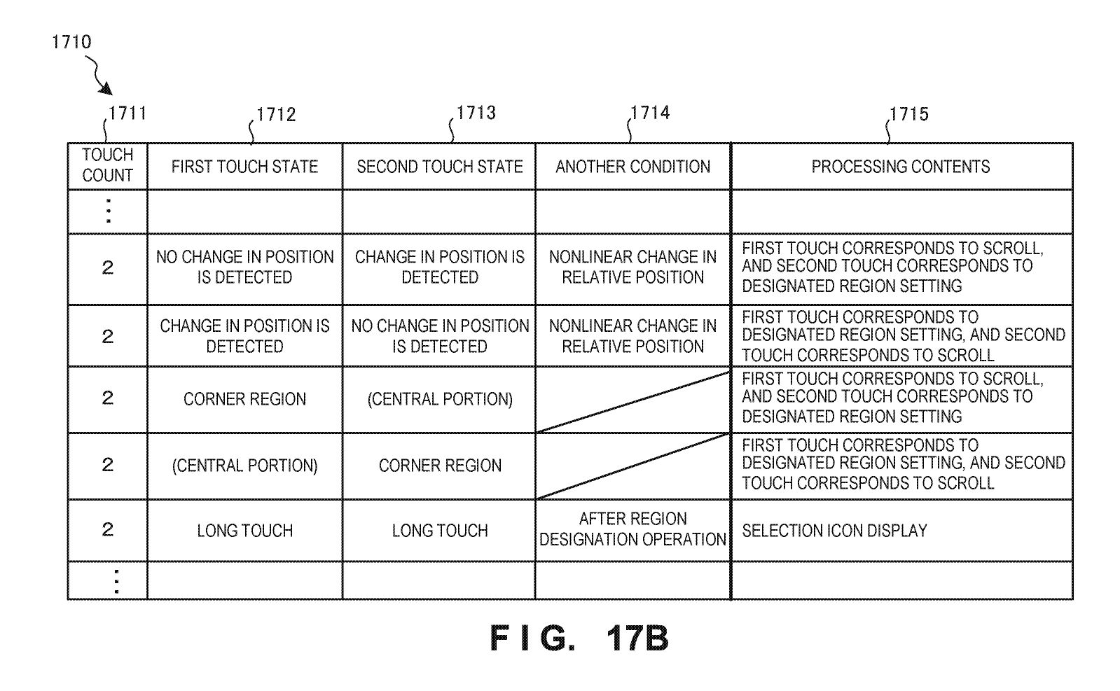

FIG. 17A is a block diagram showing the functional arrangement of a user operation determiner 1740 according to this embodiment. In FIG. 17A, the same reference numerals as in FIG. 8A denote the same functional components and a description thereof will be omitted.

If it is determined, based on long-touch information of each touch from the operation analyzer 1630, that two touches respectively having the roles of designated region setting and scroll are long touches, a selection icon generator 1704 of the user operation determiner 1740 displays the selection icon.

FIG. 17B is a table showing the structure of a user operation determination table 1710 according to this embodiment. The user operation determination table 1710 is used by the user operation determiner 1740 to determine a user operation based on a touch operation by a user's finger.

The user operation determination table 1710 stores processing contents 1715 in association with a touch count 1711, first touch state 1712, second touch state 1713, and another condition 1714. Since the user operation determination table 1710 stores the same data as in FIG. 13, data according to this embodiment will be described below.

In this embodiment, if, as a subsequent operation after a designated region setting operation, which is stored as the other condition 1714, it is determined that both the first and second touches are long touches, the selection icon is displayed as the processing contents 1715.

### Procedure of Screen Operation Processing

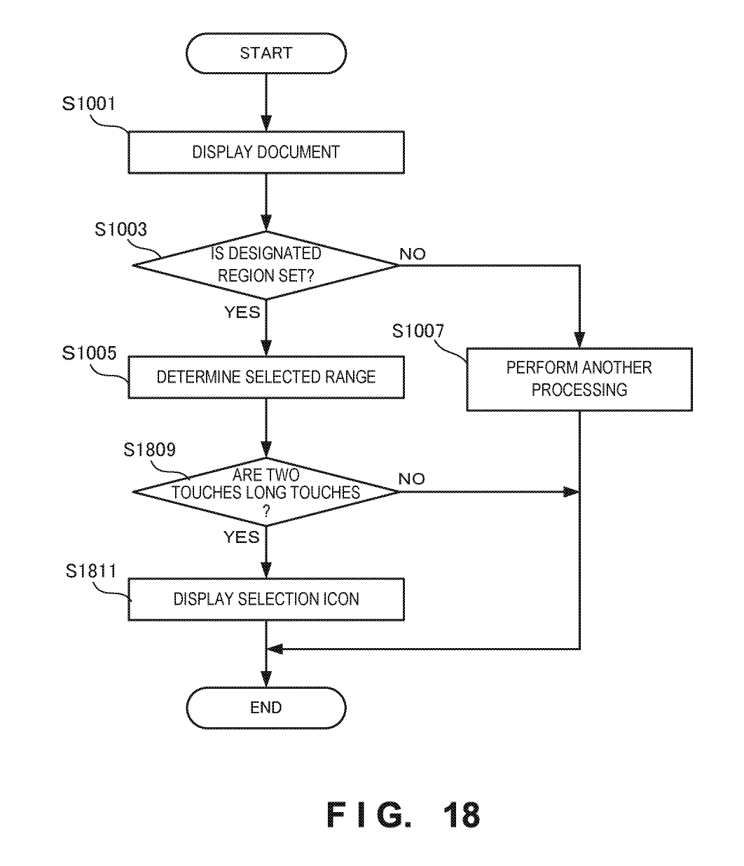

FIG. 18 is a flowchart illustrating the procedure of screen operation processing by the information processing apparatus 200 according to this embodiment. This flowchart implements the respective functional components of a screen operation processor 410 when executed by a processor 400 or the CPU of the screen operation processor 410. A case in which the CPU of the screen operation processor 410 executes the flowchart will be described. Note that in FIG. 18, the same step numbers as in FIG. 10 denote the same steps and a description thereof will be omitted.

In step S1809, the screen operation processor 410 determines whether the two touches are long touches. If the two touches are long touches, the screen operation processor 410 displays the selection icon in step S1811.

According to this embodiment, since processing following designated region setting by two touches can be implemented by performing long touch operations as the two touches, a series of processes by the user can be seamlessly implemented.

### Other Embodiments

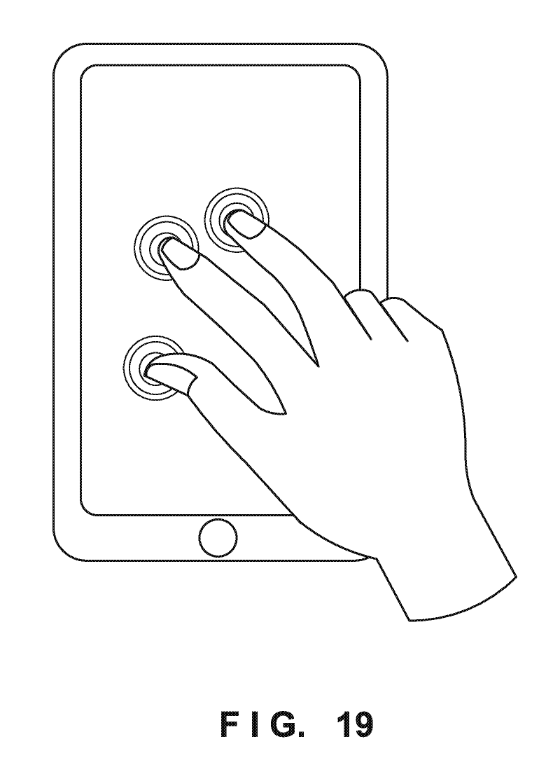

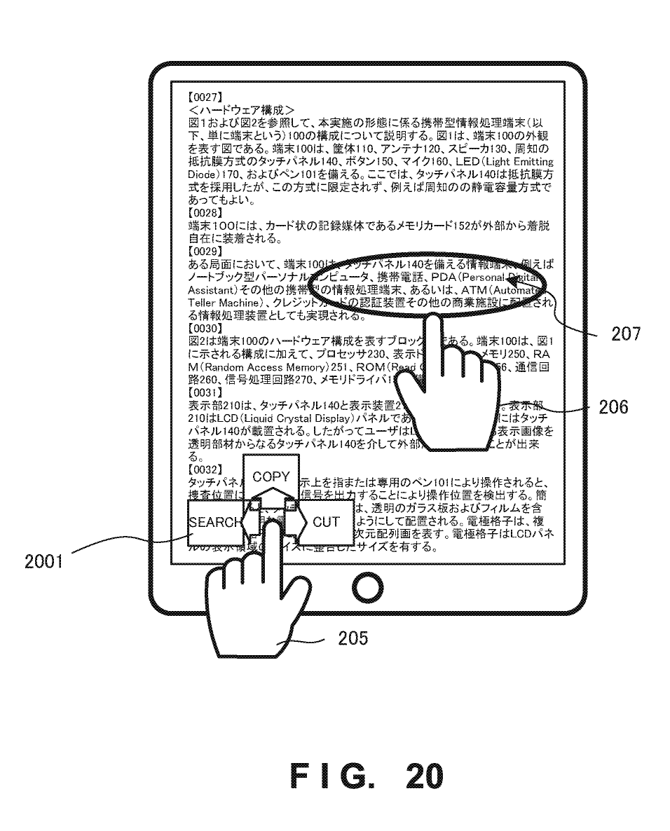

Note that the processing for horizontal writing has been described in the above embodiments. However, the same processing can be applied to the case of vertical writing to obtain the same effects. Although the document has been exemplified as a content displayed on the screen in the above embodiments, the present invention is not limited to this. Although the above embodiments have described a case in which touch operations are performed with two fingers, the present invention is not limited to this. For example, the present invention is applicable to a case in which three or more fingers touch a touch panel, as shown in FIG. 19. For example, a designated region can be set while enlarging or reducing the screen. Furthermore, the above embodiments have described an example in which the second touch is used for scroll. The present invention, however, is not limited to this. For example, as shown in FIG. 20, while determining an internal region 207 of a document or the like by setting a designated region by the first touch with a right hand 206, the way (copy, cut, search, or the like) of using the selected range may be determined by the second touch with a left hand 205. For example, an operation selection icon 2001 may be displayed near the second touch, and an operation according to the moving direction of the second touch may be performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-059240 filed on Mar. 20, 2014, which is hereby incorporated by reference herein in its entirety.

1. An information processing apparatus comprising:
a touch detector that detects presence of a first touch and a second touch on a touch panel;
a position change detector that detects a change in a position of each of the first touch and the second touch; and
a designated region setting estimator that estimates that the change in the position of the first touch is to set a designated region in a screen displayed on the touch panel, if said position change detector detects the change in the position of the first touch and detects no change in the position of the second touch.

2. The information processing apparatus according to claim 1, further comprising:
a scroll estimator that estimates that the change in the position of the second touch is to scroll the screen, if said position change detector detects the change in the position of the first touch and detects no change in the position of the second touch.

3. The information processing apparatus according to claim 2, wherein
said designated region setting estimator estimates that the change in the position of the first touch is to set a designated region in the screen displayed on the touch panel, if the second touch falls within a predetermined region at a corner of the touch panel, and
said scroll estimator estimates that the change in the position of the second touch is to scroll the screen, if the second touch falls within the predetermined region at the corner of the touch panel.

4. The information processing apparatus according to claim 1, further comprising:
a scaling processor that performs one of scaling-up display processing and scaling-down display processing of a content displayed on the touch panel, if one or both of the first touch and the second touch move in a direction in which the positions of the first touch and the second touch are linearly spaced apart from each other or close to each other.

5. The information processing apparatus according to claim 1, further comprising:
a rotation processor that performs rotation processing of the content displayed on the touch panel in a direction of moving touch, if the position of one of the first touch and the second touch moves to draw an arc about the other touch.

6. The information processing apparatus according to claim 1, further comprising:
a display controller that displays selection icons for selecting processing, if it is determined that both the first touch and the second touch are long touches.

7. An information processing method comprising:
detecting presence of a first touch and a second touch on a touch panel;
detecting a change in a position of each of the first touch and the second touch; and
estimating that the change in the position of the first touch is to set a designated region in a screen displayed on the touch panel, if the change in the position of the first touch is detected and no change in the position of the second touch is detected in the detecting the change.

8. A non-transitory computer-readable storage medium storing an information processing program for causing a computer to execute a method, comprising:
detecting presence of a first touch and a second touch on a touch panel;
detecting a change in a position of each of the first touch and the second touch; and
estimating that the change in the position of the first touch is to set a designated region in a screen displayed on the touch panel, if the change in the position of the first touch is detected and no change in the position of the second touch is detected in the detecting the change.
